(19) United States
(12) Patent Application Publication
(10) Pub. No.: US 2023/0083630 A1
(43) Pub. Date: Mar. 16, 2023

(54) WORKING TABLE FOR REEL-TO-REEL PROCESS

(71) Applicant: HAESUNG DS CO., LTD., Gyeongsangnam-do (KR)

(72) Inventor: Jongwoo Park, Gyeonggi-do (KR)

(21) Appl. No.: 17/823,984

(22) Filed: Sep. 1, 2022

(30) Foreign Application Priority Data
Sep. 10, 2021 (KR) 10-2021-0121165

(51) Int. Cl. B23Q 1/64; B65H 18/10

(52) U.S. Cl. CPC B23Q 1/64; B65H 18/103

(57) ABSTRACT

A working table for a reel-to-reel process includes: a supply reel configured to supply a workpiece; a collection reel configured to collect the workpiece after the workpiece is processed; a base on which the supply reel and the collection reel are installed; a processing workbench installed on the base to process the workpiece thereon; at least one balance adjuster installed on the base and configured to be moved according to weight variations of the supply reel and the collection reel; a balance drive unit configured to drive the at least one balance adjuster; and a controller configured to control the balance drive unit.

### CROSS-REFERENCE TO RELATED APPLICATION

This application is based on and claims priority under 35 U.S.C. § 119 to Korean Patent Application No. 10-2021-0121165, filed on Sep. 10, 2021, in the Korean Intellectual Property Office, the disclosure of which is incorporated by reference herein in its entirety.

### BACKGROUND

### 1. Field

One or more embodiments relate to a working table for a reel-to-reel process.

### 2. Description of the Related Art

A reel-to-reel process, also called a roll-to-roll process, is a process in which a flexible workpiece or the like is wound on a reel or unwound from a reel to process the flexible workpiece. Reel-to-real processes are widely used in various fields because reel-to-reel processes contribute to increasing productivity and reducing costs by enabling processing in large quantities.

In a reel-to-reel process, a supply reel and a collection reel, on which a flexible workpiece is wound, are used, and support devices capable of supporting the supply reel and the collection reel are also used.

Korean Patent Application Laid-Open Publication No. 10-2006-0045539 discloses a structure for a reel-to-reel process. That is, Korean Patent Application Laid-Open Publication No. 10-2006-0045539 discloses a laser processing machine including a supply reel and a winding reel on which a sheet-shape workpiece is wound and configured to perform a laser processing process by moving the sheet-shape workpiece to a processing table. However, in the technique disclosed in Korean Patent Application Laid-Open Publication No. 10-2006-0045539, the distance that the sheet-shape workpiece moves is long because the supply reel and the winding reel are arranged adjacent to each other, and there is a high risk of wrinkles on the sheet-shape workpiece because the sheet-shape workpiece is folded or bent while passing through many guide rollers and reversing rollers.

### SUMMARY

One or more embodiments include a working table improved for a reel-to-reel process.

Additional aspects will be set forth in part in the description which follows and, in part, will be apparent from the description, or may be learned by practice of the presented embodiments of the disclosure.

According to one or more embodiments, a working table for a reel-to-reel process includes: a supply reel configured to supply a workpiece; a collection reel configured to collect the workpiece after the workpiece is processed; a base on which the supply reel and the collection reel are installed; a processing workbench installed on the base to process the workpiece thereon; at least one balance adjuster installed on the base and configured to be moved according to weight variations of the supply reel and the collection reel; a balance drive unit configured to drive the at least one balance adjuster; and a controller configured to control the balance drive unit.

The working table may further include a supply reel rotating unit configured to rotate the supply reel.

The working table may further include a collection reel rotating unit configured to rotate the collection reel.

The at least one balance adjuster may include: a weight portion; and a movable portion on which the weight portion is provided, the movable portion being configured to be moved by power received from the balance drive unit.

The movable portion may include a nut portion, and the balance drive unit may include a transfer screw coupled to the nut portion.

The movable portion may include a movement guide, and the base may include a base guide configured to guide movement of the movable portion together with the movement guide.

At least one sensor may be stalled on the base to measure inclination of the base.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic perspective view illustrating a laser processing machine including a working table according to an embodiment;

FIG. 2 is a schematic view illustrating an operation of the working table according to an embodiment;

FIG. 3 is a schematic perspective view illustrating a balance adjuster according to an embodiment;

FIG. 4 is a schematic side view illustrating an operation of the working table according to an embodiment, in which a large portion of a workpiece is wound on a supply reel at an initial stage of the operation; and

FIG. 5 is a schematic side view illustrating the operation of the working table according to the embodiment, in which a large portion of the workpiece is wound on a collection reel at a late stage of the operation.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, example embodiments will be described with reference to the accompanying drawings. In the detailed description and the drawings, like reference numerals denote like elements, and overlapping descriptions thereof will be omitted. Furthermore, in the drawings, the sizes of elements, the length ratios of elements, or the like may be exaggerated for clarity of illustration.

Aspects of the present disclosure will be clarified through the accompanying drawings and descriptions of embodiments. The embodiments may, however, have different forms and should not be construed as being limited to the descriptions set forth herein. Rather, these embodiments are provided such that this disclosure will be thorough and complete, and will fully convey the scope of the inventive concept to those skilled in the art. Therefore, the scope of the present disclosure should be defined by the following claims.

In the following description, technical terms are used only for explaining embodiments, and not for purposes of limitation. Terms in the singular form may include the plural form unless specifically mentioned. The meaning of “comprises” and/or “comprising” specifies an element, a step, a process, an operation, and/or a device but does not exclude other elements, steps, processes, operations, and/or devices. It will be understood that although terms such as first, second, upper surface, and lower surface are used herein to describe various elements, these elements should not be limited by these terms. These terms are only used to distinguish one element from other elements.

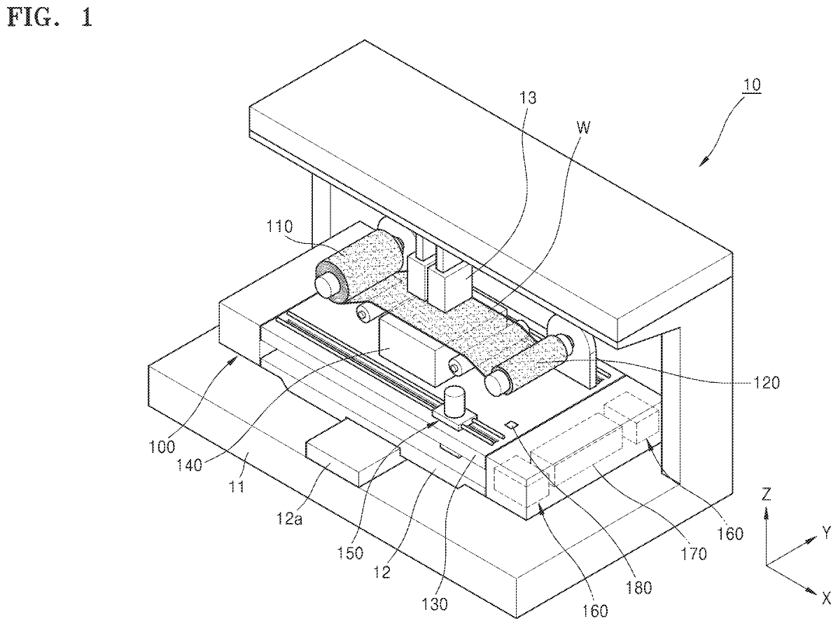

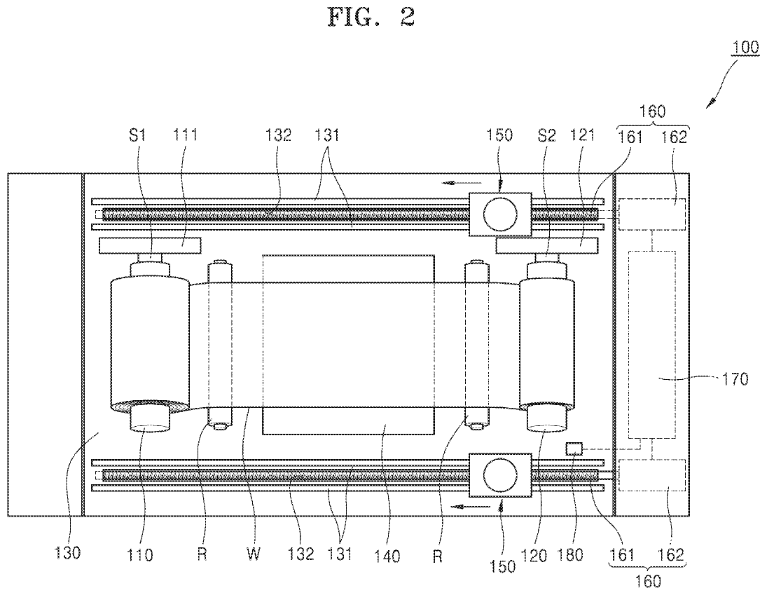

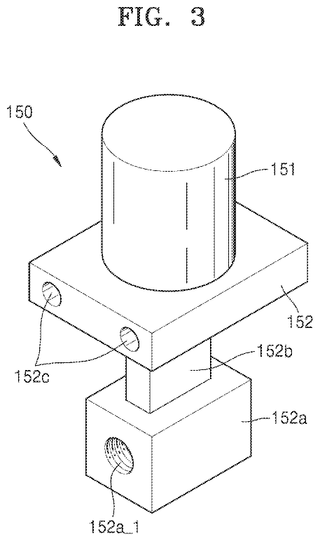

FIG. 1 is a schematic perspective view illustrating a laser processing machine 10 including a working table 100 according to an embodiment. FIG. 2 is a schematic view illustrating an operation of the working table 100 according to an embodiment. FIG. 3 is a schematic perspective view illustrating a balance adjuster 150 according to an embodiment.

Referring to FIG. 1, according to an embodiment, the working table 100 is applied to the laser processing machine 10.

In the embodiment, the working table 100 is applied to the laser processing machine 10. However, embodiments are not limited thereto. That is, in addition to being applicable to a laser processing machine, the working table 100 of the present disclosure may be applied to any other device for reel-to-reel processes without limitation. For example, the working table 100 may be applied to various devices such as a screen printing device and an etching device which use reel-to-reel processes.

The laser processing machine 10 includes a frame 11, a movable table 12, a laser processing head 13, and the working table 100.

The frame 11 has a function of supporting the overall structure of the laser processing machine 10, and the movable table 12 is installed on the frame 11 and movable in a Y direction.

The movable table 12 is configured to support the working table 100 and may move in the Y direction along a transfer lane 12a. Therefore, an operator may move the transfer table 12 in the opposite direction of the Y direction to set a supply reel 110, a collection reel 120, a processing workbench 140, or the like on the working table 100, and may then move the transfer table 12 in the Y direction to return the working table 100 to a working position.

The laser processing head 13 is a device for performing a laser processing process such as a hole forming process, and to this end, the laser processing head 13 includes a laser oscillator, a plurality of mirrors, a lens, and the like.

The working table 100 is installed on the movable table 12. The working table 100 includes the supply reel 110, the collection reel 120, a base 130, the processing workbench 140, balance adjusters 150, balance drive units 160, a controller 170, and a sensor 180.

The supply reel 110 supplies a workpiece W, which is wound around the supply reel 110 before being processed. The type or form of the workpiece W is not particularly limited as long as the workpiece W is a flexible material. According to an embodiment, the workpiece W may be a flexible substrate.

A supply reel rotating unit 111 rotates the supply reel 110. That is, the supply reel 110 is connected to a rotation shaft S1 of the supply reel rotating unit 111 such that the supply reel 110 may be rotated by the supply reel rotating unit 111. The supply reel rotating unit 111 may include components such as a driving motor (not shown), a speed reducer, or an encoder for measuring a rotation angle, and may exchange signals with the controller 170 for rotating the supply reel 110.

Because the supply reel rotating unit 111 is installed on the base 130, the supply reel 110 is installed on the base 130.

According to an embodiment, the supply reel rotating unit 111 actively rotates the supply reel 110, but embodiments are not limited thereto. That is, in other embodiments, the supply reel rotating unit 111 may not actively rotate the supply reel 110. In that case, the workpiece W may be moved by the rotation of the collection reel 120.

An auxiliary roller R is disposed between the supply reel 110 and the processing workbench 140 to appropriately adjust the tension of the workpiece W moving toward the processing workbench 140, thereby preventing the workpiece W from wrinkling.

After being processed, the workpiece W is wound around the collection reel 120, and thus the workpiece W is collected by the collection reel 120.

A collection reel rotating unit 121 rotates the collection reel 120. That is, the collection reel 120 is connected to a rotation shaft S2 of the collection reel rotating unit 121 such that the collection reel 120 may be rotated by the collection reel rotating unit 121. The collection reel rotating unit 121 may include components such as a driving motor (not shown), a speed reducer, or an encoder for measuring a rotation angle, and may exchange signals with the controller 170 for rotating the collection reel 120.

Because the collection reel rotating unit 121 is installed on the base 130, the collection reel 120 is installed on the base 130.

An auxiliary roller R is disposed between the collection reel 120 and the processing workbench 140 to appropriately adjust the tension of the workpiece W moving toward the collection reel 120, thereby preventing the workpiece W from wrinkling.

In addition, the base 130 has a plate-like shape, and the supply reel 110, the collection reel 120, the processing workbench 140, the balance adjusters 150, and the like are installed on the base 130.

The base 130 includes four base guides 131, and the base guides 131 guide the movements of movable portions 152 of the balance adjusters 150. The base guides 131 has a rod shape having a circular cross section.

According to an embodiment, four base guides 131 with a rod shape having a circular cross section are provided, but embodiments are not limited thereto. That is, the number and shape of the base guides 131 are not particularly limited in the present disclosure. For example, in an embodiment, the number of base guides 131 may be one, two, three, five, six, or the like. Furthermore, in an embodiment, base guides 131 may have a rod shape having a rectangular cross section, or may have a rail shape extending from an upper surface of the base 130.

In the embodiment, the base 130 includes the base guides 131, but embodiments are not limited thereto. That is, in other embodiments, the base 130 may not include the base guides 131.

Long guide holes 132 are formed in portions of the base 130 between the base guides 131. Connection portions 152b of the balance adjusters 150 are movably arranged in the long guide holes 132.

In an embodiment, the long guide holes 132 are formed in the base 130, but embodiments are not limited thereto. That is, in other embodiments, the long guide holes 132 may not be formed in the base 130.

In addition, the processing workbench 140 is installed on the base 130 such that workpieces W may be processed on the processing workbench 140. In an embodiment, a workpiece W placed on the processing workbench 140 is processed with a laser.

The balance adjusters 150 are symmetrically installed, as a pair, on the base 130 and are configured to move according to variations in the weight of the supply reel 110 and the weight of the collection reel 120.

In an embodiment, a pair of balance adjusters 150 are symmetrically installed on the base 130, but embodiments are not limited thereto. That is, in embodiments, the number and arrangement of balance adjusters 150 installed on the base 130 are not particularly limited. For example, the number of balance adjusters 150 may be one, three, four, five, or the like, and the balance adjusters 150 may be asymmetrically installed on the base 130.

As shown in FIG. 3, each of the balance adjusters 150 includes a weight portion 151 and the movable portion 152.

The weight portion 151 servers as a weight, and is designed through repeated experiments such that the weight portion 151 may have an optimal weight for balancing the working table 100.

The weight portion 151 is provided on the movable portion 152, and the movable portion 152 is moved by power from one of the balance drive units 160. To this end, the movable portion 152 includes a nut portion 152a, and a screw hole 152a_1 of the nut portion 152a is coupled to a transfer screw 161 of the balance drive unit 160.

The movable portion 152 is connected to the nut portion 152a through the connection portion 152b, and the connection portion 152b is movably installed in a long guide hole 132 of the base 130. Thus, the movable portion 152 is moved while being guided along the long guide hole 132.

In an embodiment, the movable portion 152 is connected to the nut portion 152a through the connection portion 152b, but embodiments are not limited thereto. That is, in other embodiments, the connection portion 152b may not be provided. In this case, a hole may be formed in the movable portion 152, and a screw thread may be formed on an inner surface of the hole, such that the movable portion 152 may also have the function of the nut portion 152a. In this case, the long guide hole 132 may not be formed in the base 130.

The movable portion 152 includes movement guides 152c. The movement guides 152c include guide holes. The movement guides 152c guide the movement of the movable portion 152 together with base guides 131. To this end, the base guides 131 are installed such that the base guides 131 may extend through the movement guides 152c.

The balance drive units 160 drive the balance adjuster 150.

Each of the balance drive units 160 includes the transfer screw 161 and a motor 162, and is disposed on a side surface of the base 130.

The transfer screw 161 is coupled to the screw hole 152a_1 of the nut port 152a such that a rotational motion of the transfer screw 161 may be converted into a linear motion of the nut portion 152a.

In an embodiment, each of the balance drive units 160 includes the transfer screw 161, and the movable portion 152 includes the nut portion 152a, such that the movable portion 152 is moved by a screw transfer device. However, embodiments are not limited thereto. That is, the movable portion 152 of the present disclosure is not limited to a particular moving method. For example, in other embodiments, the movable portion 152 may be moved by a rope drive device, a chain drive device, a belt drive device, or a linear drive device.

The motor 162 rotates the transfer screw 161 under the control of the controller 170 and may be configured as a geared motor.

In an embodiment, the motor 162 may be configured as a geared motor, but embodiments are not limited thereto. That is, in other embodiments, the motor 162 of each of the balance drive units 160 may not be configured as a geared motor, and in this case, a separate speed reducer may be additionally connected to the motor 162.

The controller 170 is configured to control the balance drive units 160 based on a predetermined program. That is, the controller 170 controls the balance drive units 160 by reflecting variations in the weight of the supply reel 110 and the weight of the collection reel 120. For example, the controller 170 may feedback control the balance drive units 160 using a signal received from the sensor 180.

The controller 170 may include hardware such as an electric circuit board or an integrated circuit chip, software, firmware, or the like which is capable of processing data, and may be operated under the control of a user or a control algorithm.

The controller 170 may be configured exclusively for the working table 100, but embodiments are not limited thereto. That is, the controller 170 may be integrated with a controller of a device to which the working table 100 is applied. For example, the controller 170 may be integrated with a controller of the laser processing machine 10 according to an embodiment.

At least one sensor 180 is installed on the base 130 to measure the inclination of the base 130 and transmit results of the measurement to the controller 170. The controller 170 may receive an inclination signal from the sensor 180 and may use the inclination signal for feedback control.

Any type or form of sensor may be used as the sensor 180 as long as the sensor is capable of measuring the inclination of the base 130. For example, various sensors such as an accelerometer, an angle sensor or the like as well as a general inclination sensor may be used.

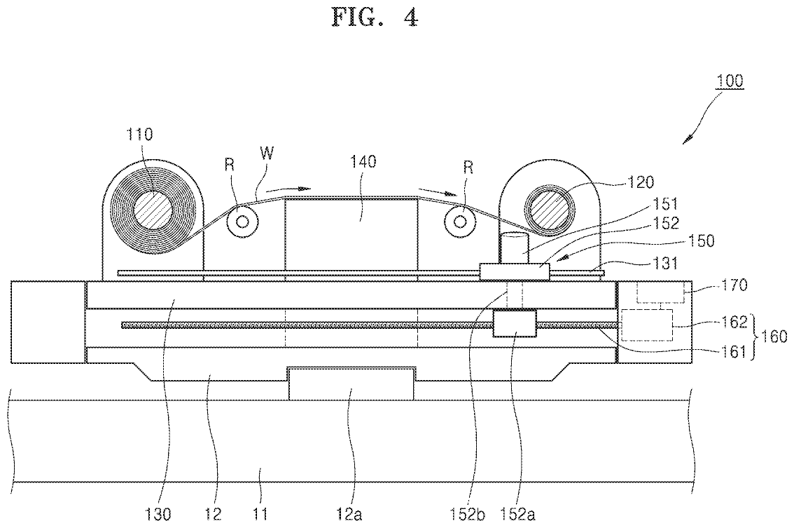

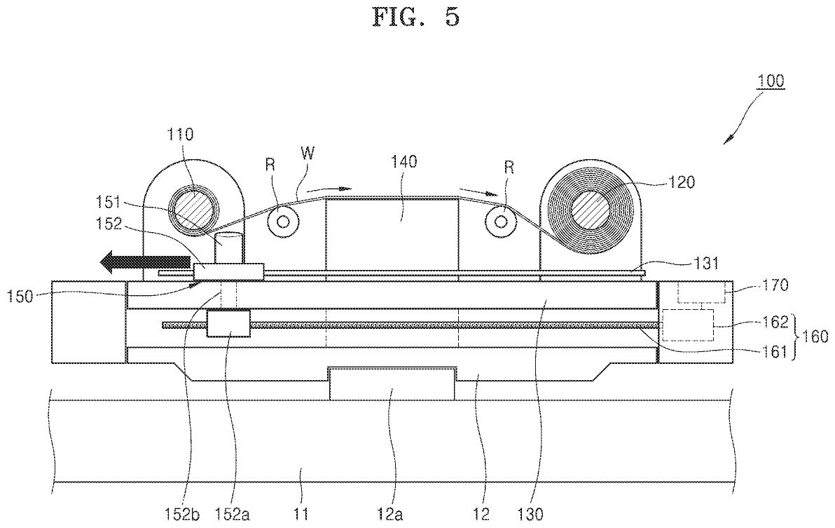

In an embodiment, the working table 100 includes the sensor 180, but embodiments are not limited thereto. That is, in other embodiments, the working table 100 may not include a sensor. Hereinafter, an operation of the working table 100 will be described according to an embodiment with reference to FIGS. 4 and 5.

FIG. 4 is a schematic side view illustrating an operation of the working table 100 according to an embodiment, in which a large portion of a workpiece W is wound on the supply reel 110 at an initial stage of the operation, and FIG. 5 is a schematic side view illustrating the operation of the working table according to the embodiment, in which a large portion of the workpiece W is wound on the collection reel 120 at a late stage of the operation.

As shown in FIG. 4, a large portion of the workpiece W is wound on the supply reel 110 in the initial stage of the operation. The workpiece W is released from the supply reel 110 and moved to the processing workbench 140 for being laser processed, and after the laser processing, the workpiece W is moved to the collection reel 120 and wound on the collection reel 120. In this process, the weight of the supply reel 110 gradually reduces, and the weight of the collection reel 120 gradually increases.

In addition, the controller 170 may measure the number of rotations (rotation angle) of each of the supply reel 110 and the collection reel 120 and may calculate variations in the weight of the supply reel 110 and the weight of the collection reel 120 according to the transfer of the workpiece W.

In the current embodiment, variations in the weight of the supply reel 110 and the weight of the collection reel 120 are calculated by measuring the number of rotations (rotation angle) of each of the supply reel 110 and the collection reel 120. However, embodiments are not limited thereto. That is, in embodiments, the method of calculating variations in the weight of the supply reel 110 and the weight of the collection reel 120 is not particularly limited. For example, variations in the weight of the supply reel 110 and the weight of the collection reel 120 may be measured using load sensors, which are respectively installed on the supply reel rotating unit 111 and the collection reel rotating unit 121 to measure loads applied from the supply reel 110 and the collection reel 120 to the rotation shafts S1 and S2.

The controller 170 drives the balance drive units 160 according to variations in the weight of the supply reel 110 and the weight of the collection reel 120. That is, the controller 170 balances the base 130 by driving the balance drive units 160 to move the balance adjusters 150.

For example, the controller 170 rotates the transfer screws 161 by driving the motors 162, and then the nut portions 152a receive power from the transfer screws 161, thereby moving the balance adjusters 150. That is, the balance adjusters 150 having the weight portions 151 are moved in a direction from the collection reel 120 toward the supply reel 110 as shown in FIG. 5, and thus an imbalance caused by a decrease in the weight of the supply reel 110 may be redressed.

Furthermore, during the process described above, the sensor 180 may measure the inclination of the base 130 and may send results of the measurement to the controller 170 for feedback control. For example, when there is an imbalance because the balance adjusters 150 are excessively moved toward the supply reel 110 by inertial force or the like, balance control may be performed by measuring slope variations with the sensor 180 and slightly moving the balance adjusters 150 back toward the collection reel 120.

When the balance of the working table 100 is maintained as described above, stable supporting is possible during processing work. Therefore, when the working table 100 of the current embodiment is applied to the laser processing machine 10, laser processing precision may be increased through precise position control, and thus processing quality may be improved.

As described above, according to an aspect of the present disclosure, the working table 100 for a reel-to-reel process is configured such that even when a flexible workpiece W is moved from the supply reel 110 to the collection reel 120, the center of gravity of the working table 100 may be maintained constant because the balance adjusters 150 correct imbalance in weight. Therefore, the working table 100 may improve the quality of processed products through precise control and processing.

According an aspect of the present disclosure, the working table 100 for a reel-to-reel process is configured such that even when a flexible workpiece W is moved from the supply reel 110 to the collection reel 120, the working table 100 may maintain balance by correcting weight imbalance and may thus improve the quality of processed products through precise control and processing.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

### INDUSTRIAL APPLICABILITY

According to embodiments, the working table 100 may be applied to the working-table manufacturing industry and other industries using working tables.

What is claimed is:

1. A working table for a reel-to-reel process, the working table comprising:
a supply reel configured to supply a workpiece;
a collection reel configured to collect the workpiece after the workpiece is processed;
a base on which the supply reel and the collection reel are installed;
a processing workbench installed on the base to process the workpiece thereon;
at least one balance adjuster installed on the base and configured to be moved according to weight variations of the supply reel and the collection reel;
a balance drive unit configured to drive the at least one balance adjuster; and
a controller configured to control the balance drive unit.

2. The working table of claim 1, further comprising a supply reel rotating unit configured to rotate the supply reel.

3. The working table of claim 1, further comprising a collection reel rotating unit configured to rotate the collection reel.

4. The working table of claim 1, wherein the at least one balance adjuster comprises:
a weight portion; and
a movable portion on which the weight portion is provided, the movable portion being configured to be moved by power received from the balance drive unit.

5. The working table of claim 4, wherein the movable portion comprises a nut portion, and
the balance drive unit comprises a transfer screw coupled to the nut portion.

6. The working table of claim 4, wherein the movable portion comprises a movement guide, and
the base comprises a base guide configured to guide movement of the movable portion together with the movement guide.

7. The working table of claim 1, wherein at least one sensor is installed on the base to measure inclination of the base.
